(19) United States
(12) Patent Application Publication
(10) Pub. No.: US 2007/0148392 A1
(43) Pub. Date: Jun. 28, 2007

(54) Pad assembly

(76) Inventors: Laurent Keravec, Taverny (FR); Caroline Roque, L'Isle-Adam (FR)

Correspondence Address: 3M INNOVATIVE PROPERTIES COMPANY, PO BOX 33427, ST. PAUL, MN, 55133-3427, US

(21) Appl. No.: 10/583,819

(22) PCT Filed: Dec. 17, 2004
(86) PCT No.: PCT/US04/42555

§ 371 Date: Jun. 21, 2006

(30) Foreign Application Priority Data
Dec. 24, 2003 (EP) 03029852.5

(51) Int. Cl. B32B 33/00

(52) U.S. Cl. 428/40.1; 428/194; 428/202

(57) ABSTRACT

A pad assembly comprising, a plurality of flexible rectangular sheets (42), each sheet being generally of the same size and said sheets (42) having front (41) and rear (43) surfaces and peripheral edges including first (15) and second (16) opposite edges, said sheets having a band (40) of repositionable pressure sensitive adhesive coated on said rear surface (43) for adhering adjacent sheets together Said stripes (40) being substantially parallel to the first (15) and second (16) edges and being spaced by a first predetermined spacing (1) from said first edge (15) and by a second predetermined spacing (2) from said second edge (16), wherein the ratio between the spacing from the edge (19) of the band (40) closest to said first edge (15) to said first edge and the spacing from the edge (20) of the band (40) closest to said second edge to said second edge (16) is in the range of 0.1 to 10.

The present invention relates to pad assemblies comprising a plurality of flexible sheets. More particularly the invention relates to note pad assemblies comprising a plurality of aligned discrete flexible rectangular sheets in a pad, which are attached together so that the uppermost individual sheet in the pad can be separated from the pad. The individual sheets have a band of repositionable pressure sensitive adhesive coated on the rear surface, so that the separated sheets can be used elsewhere, e.g. can be positioned, typically on letters, files or vertical surfaces or walls in a room by means of the adhesive coated rear side, so that the separated sheets with any information on it can be easily viewed.

U.S. Pat. No. 5,153,041 describes a pad assembly primarily to be used as a flip chart, wherein the flip chart consists of a number of sheets which at one end are held together by a layer of padding compound, from which in a conventional manner the individual sheets can be removed. Each sheet has a band of repositionable pressure sensitive adhesive coated on its rear surface adjacent and spaced by a small predetermined spacing from a first edge, this spacing providing a tactile feel restricting the inadvertent separation of the sheet from the pad held together by the layer of the padding-compound. A purpose of this construction is to allow a permanent removal of an individual sheet and to apply it separately at some other location utilizing the repositionable pressure sensitive adhesive layer.

U.S. Pat. No. 5,299,833 relates to a flip chart or easel pad, wherein the individual sheets of the flip chart are held together through the use of staples or screws. Additionally, the individual layers are provided with stripes of adhesive, which are placed towards the edge at the end where the staples or screws hold the sheets together. The stripes of adhesive have a spacing towards the edge of the individual sheets. The sheets are provided with perforation lines, wherein the purpose of these perforation lines is to remove the individual sheets of the flip chart on either side of the adhesive stripe.

U.S. Pat. No. 5,618,062 relates to a method for making custom printed notes or note pads. One or more sheet assemblies are provided which have first and second sheets and a pattern of pressure-sensitive adhesive on the rear major surface of each of the sheets that contacts and is releasably adhered to the rear major surface of the other sheet only in non-adhesive areas. The sheets can either be cut along predetermined lines to form the custom printed notes, or the sheets of a plurality of such printed sheet assemblies can be separated, stacked to adhere the patterns of pressure-sensitive adhesive on the rear major surfaces of the sheets to the front major surfaces of the sheets with the edges of the sheets in a predetermined orientation with respect to each other, and the stacked sheets can be cut along predetermined lines to form custom printed note pads.

U.S. Pat. No. 5,011,186 relates to a pad of regular hexagonal flexible sheets each having a front surface adapted to be written on, and a coating of repositionable pressure sensitive adhesive over a portion of its rear surface releasably adhering the sheet to an underlying sheet in the pad. Information can be written on the front surfaces of the” sheets, and the individual written on sheets can be adhered to a planar surface in side-by-side relationship with edge portions of up to six adjacent sheets in contact to represent relationships between the information on the sheets.

A widely used note pad assembly of the commercial brand “Post-it®” is available from 3M Company, comprising a plurality of paper sheets disposed in a pad with the corresponding edges of the sheets aligned and with each sheet having a band of repositionable pressure sensitive adhesive coated on its rear surface along aligned first edges of the sheets, and the band of repositionable pressure sensitive adhesive on each sheet adhering it to the front surface of the adjacent sheet in the pad. Sheets removed from the “Post-it®” note pad assembly can be releasably adhered to a support surface by the bands of repositionable pressure sensitive adhesive on the sheets.

A large proportion of “post-it®” notes are used in vertical position, i.e. on walls, wallpaper, or painted walls or other vertical surfaces. Although the pressure sensitive adhesive on the sheets from the “Post-it®” notes have initially been designed to adhere on papers they may also be used at vertical surfaces like walls. However, the duration of time which the individual sheets adhere to such vertical surfaces, in the following also referred as wall-hang performance, may be reduced depending on the circumstances, like the properties of the surface to which the sheets are adhered or external influences.

Furthermore, the wall-hang performance of a sheet with an adhesive band at its edge may further be reduced when the upper most sheet is removed from the pad at an angle of e.g. 180°, which may cause a curling of the sheet. The curling particularly arises at the edge portion, where the adhesive is coated at the rear side of the sheet. The curling has the effect that the opposite edge of the sheet has a certain distance from the wall.

It would now be desirable to provide a pad assembly of the type including a plurality of flexible sheets with repositionable pressure sensitive adhesive, wherein the individual sheet(s) that are separated from the pad assembly can be releasably adhered to a support surface and provide good or excellent wall-hang performance.

According to a first aspect of the present invention, there is provided a pad assembly comprising a plurality of rectangular flexible sheets, preferably paper sheets, each having a band of repositionable pressure sensitive adhesive coated on its rear surface, said band being spaced by a first predetermined spacing from a first or upper edge and spaced by a second predetermined spacing from a second or lower opposite edge. The sheets are disposed in a pad with the corresponding edges of the sheets aligned, the front and rear surfaces of adjacent sheets facing each other, and the band of repositionable pressure sensitive adhesive on each sheet adhering it to the adjacent sheet in the pad. This first and second predetermined spacings define at the rear surface of the sheets portions free of adhesive along the first and second edge, to allow removal of the sheets from the pad by peeling the upper most sheet from the underlying sheets in the pad, wherein the peeling off can be selectively initiated either at the first or second edge. The first and second predetermined spacings between the band of repositionable pressure sensitive adhesive and the first and second edge of each sheet according to the invention provide good to excellent wall-hang performance when the sheet has been separated from the pad and adhered to a non-horizontal, e.g. vertical surface. In the present application, the term “vertical surface” is meant to embrace any surface from which a sheet of the pad assembly may fall down under the ultimate effect of gravity, e.g. a surface having an inclination angle with respect to a horizontal plane of at least 30°. The front surface of some or all of the sheets is preferably adapted to be written on. Additionally the front surface of a sheet can have indicia defining areas of the sheet on which information is to be provided, if desired. Also, the front surface may be provided with indicia such as graphics to improve attractiveness of the sheets and/or the indicia may define an advertisement message.

According to another aspect of the invention, the band of pressure sensitive adhesive may comprise a plurality of repositionable pressure sensitive adhesive stripes. These stripes are preferably substantially parallel to the first and second edges of the sheets, and adhesive stripes are spaced from neighboring stripes by areas which comprise no adhesive. The neighboring areas which comprise no adhesive have a substantially rectangular shape due to the rectangular shape of the sheets, of the band and of each of the pressure sensitive adhesive stripes. The coating of pressure sensitive adhesive in a band and/or an individual stripe of a band on each sheet may extend continuously or discontinuously across the rear surface of the sheet between the two side edges. When the adhesive is applied discontinuously it is preferred that the pattern of adhesive is such that there is adhesive present adjacent to the two side edges.

An improved wall-hang performance can be achieved by a displaced band of pressure sensitive adhesive according to the invention, which is spaced by first and second predetermined spacings from both edges of each sheet. Good wall-hang performance can be achieved, as later discussed in detail, when the ratio between the first predetermined spacing from the edge of the band closest to the. first edge to said first edge and the second predetermined spacing from the edge of the band closest to the second edge to said second edge is in the range of 0.1 to 10, preferably in the range of 0.25 to 4, more preferably in the range from 0.5 to 2, from 0.8 to 1.2, from 0.9 to 1.1, and most preferably about 1. A ratio of 11 1 ″ corresponds to a band centered !n the middle of the rectangular sheet. Thus, the band of repositionable pressure sensitive adhesive may be substantially centered or only slightly displaced from the centered position. Test methods for the wall-hang performance will be described later in detail.

Preferably the coating of repositionable pressure sensitive adhesive on each sheet extends parallel to the first and second edges continuously across the rear surface of the sheet between the two side edges, which are perpendicular to the first and second edges. The rear surface has at least two portions free of adhesive adjacent to the first and second edges.

There are further benefits provided due to the adhesive band being displaced from the first and second edge of the sheet. For instance, the customer may take or peel the pad in two directions. Due to the absence of adhesive adjacent to the two edges the sheets can be easily peeled off from the pad either starting from the first edge or from the second edge. Further advantages are a good or excellent wall-hang performance without affecting compatibility with papers and without the need for a special adhesive formulation. Moreover, the sheets can easily be applied in all directions. Furthermore, the principle of having the adhesive band displaced from the first and second edges can be applied to any format of flexible sheets.

The invention provides further advantages from a manufacturing standpoint. For instance, during the cutting step the guillotines or blade will cut through the paper alone instead of cutting through the adhesive. This will reduce blades cleaning time and will further reduce the sheet removal force.

Preferably, when used as a note pad, the pad assembly may further include a protective back sheet or back card, which could be any type of paper or other material which could also be stiff. The bottom-most sheet in the pad is attached to the back sheet or back card, and the back sheet is preferably at least coextensive or aligned with the sheets in the pad and can have a top edge aligned with the first edge of the sheets. Alternatively, the back sheet or back card can have a top portion projecting past the aligned .first edges of the sheets, which top portion has a peripheral support edge generally parallel to the first edges of the sheets. The present invention will be further described with reference to the accompanying drawings wherein like reference numerals refer to like parts in the several views, and wherein:

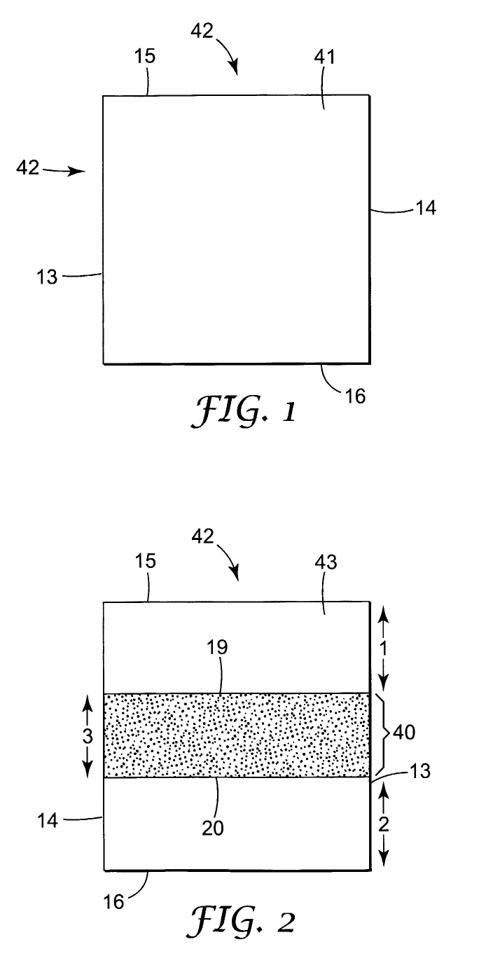

FIG. 1 is a front view of a sheet according to an embodiment of the present invention;

FIG. 2 is a rear view of the sheet of FIG. 1;

FIG. 3 is a side view of a pad assembly with sheets according to FIG. 1 and FIG. 2 illustrating a sheet being removed from the pad;

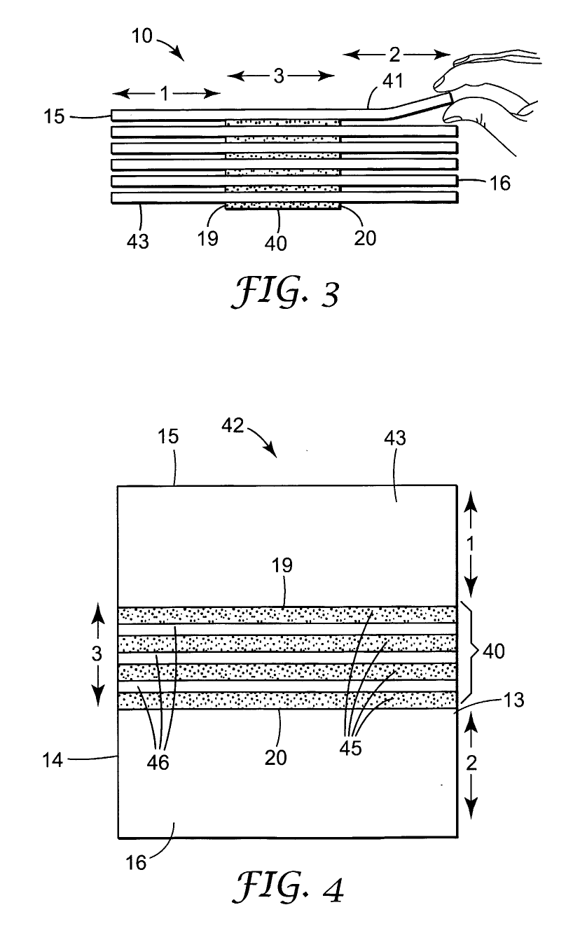

FIG. 4 is a rear view of a sheet according to another embodiment of the present invention;

FIG. 5 is a graph showing the wall-hang performance for two different types of adhesive in dependence of the displacement of the adhesive band from the first edge; and

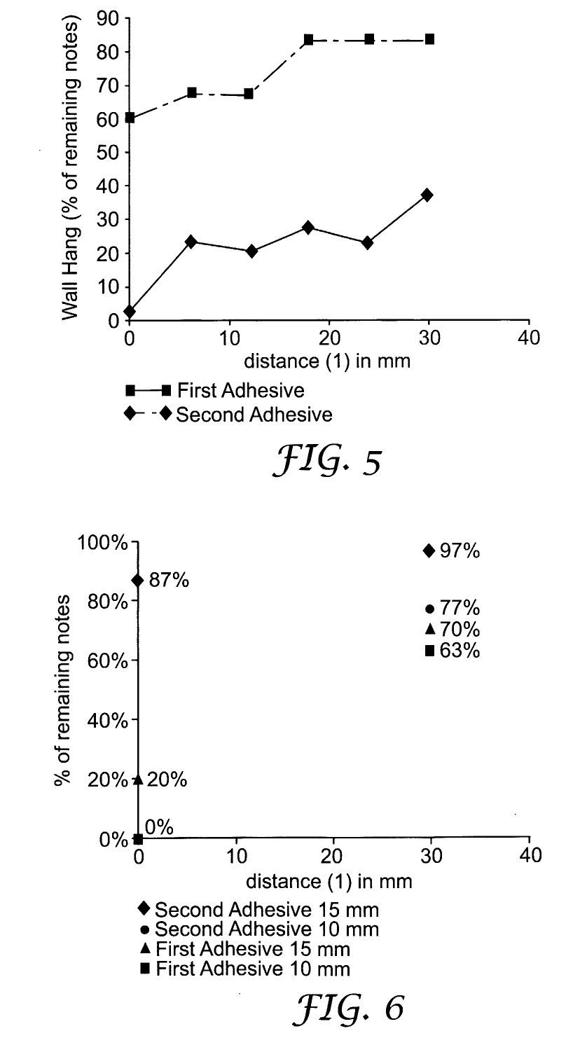

FIG. 6 is a graph showing the wall-hang performance for two different types of adhesives and additionally two different band widths in dependence of the displacement of the adhesive band.

Referring now to the drawings, there is shown a pad assembly according to the present invention generally designated by the reference numeral 10 (FIG. 3), which pad assembly 10 may in same embodiments, depending on the size of the flexible sheets, be called a “note pad”.

Generally the pad assembly 10 comprises a plurality of flexible rectangular sheets 42 (e.g., hundred sheets 42) as shown in FIG. 1 and FIG. 2 from the front and rear side. Each sheet 42 is generally of the same size, having a front surface 41 and a rear surface 43 and peripheral edges 13, 14, 15, .16 including first and second opposite edges 15, 16 and first and second side edges 13, 14 perpendicular to the said first edge 15 and said second edge 16. A band 40 (FIGS. 2, 3, 4) of reposition able pressure sensitive adhesive is coated on the rear surface spaced by a first predetermined spacing 1 from the first edge 15 and spaced by a second predetermined spacing 2 from the second edge 16. The first predetermined spacing 1 is defined as the spacing between the edge 19 of the band 40 closest to the first edge 1.5 and said first edge 15. Accordingly, the second predetermined spacing 2 is defined as the spacing between the edge 20 of the band 40 closest to the second edge 16 and said second end .16. The length and the width of the sheets are defined with respect to the pressure sensitive adhesive band 40, wherein the length is defined parallel to the direction in which the adhesive band 40 extends between the side edges 13 and 14. The width of the sheets 62 is defined parallel to the width of the adhesive band 40. The sheets 42 are disposed in a pad 10 with the corresponding peripheral edges of the sheets 42 aligned, the front 41 and rear 43 surfaces of adjacent sheets 42 facing each other, and the band 40 of repositionable pressure sensitive adhesive on each sheet 42 adhering said sheet to the adjacent sheet 42 in the pad. Due to the adhesive band 40 at each sheet, which adheres each. sheet to the adjacent lower sheet, there is no need for any further padding compound disposed at any of the aligned peripheral edges to form a pad assembly.

FIG. 3 depicts a schematic side view of a pad assembly 10, wherein the height of the adhesive band 40 is depicted oversized and not to scale. From this side view, it can be seen that, due to the portion free of adhesive adjacent to the first edge 15 and to the second edge 16, the user can peel off the upper most sheet either from the first edge 15, which corresponds to the left hand side of FIG. 3, or from the opposite second edge 16, which corresponds to the right hand side of FIG. 3. Furthermore, it can be seen that each adhesive band 40 of a sheet is aligned with the bands 40 of the adjacent sheets.

FIG. 4 shows the rear side of another embodiment of the sheet according to the present invention, wherein the adhesive band 40 comprises a plurality of repositionable pressure sensitive adhesive stripes 45. These adhesive stripes 45 are substantially parallel to the first edge 15 and the second edge 16. The stripes of the plurality of adhesive stripes 45 are spaced by neighboring areas 46 which do not comprise adhesive. The adhesive stripes 45 and the interval areas 46 without adhesive together define the adhesive band 40 with a width 3, with the edges 19 and 20 being defined as the edges of the band 40.

Preferably, the band 40 of repositionable pressure sensitive adhesive extends parallel to the first edge 15. In one embodiment the band 40 is continuous and has a width 3 in a direction perpendicular to the first edge 15. In other embodiments of the invention. the band may comprise intervals without pressure sensitive adhesive and extend discontinuously between the side edges. The ratio between the area of the rear side which is coated with adhesive to the area without adhesive is preferably in the range of 0.1 to 0.4, more preferably in the range of 0.2 to 0.3 and most preferably about 0.27. The width 3 of the band 40 is selected such that the ratio between said width 3 and the sum of the first predetermined spacing 1 and the second predetermined spacing 2 is preferably in the range of 0.1 to 0.4, more preferably in the range of 0.2 to 0.3 and most preferably about 0.27.

The repositionable pressure sensitive adhesive used to form the band 40 can be of the type as described in U.S. Pat. No. 3,691,140, in the following also referred as “first adhesive”. The repositionable pressure sensitive adhesive described in U.S. Pat. No. 3,691,140 comprises infusible, solvent-dispersible, solvent-insoluble, inherently tacky, elastomeric copolymer microspheres. The microspheres preferably consist essentially of about 90 percent to about 99.5 percent by weight of at least one alkyl acrylate ester and about 10 to about 0.5 percent by weight of at least one monomer selected from the group consisting of substantially oil-insoluble, water-soluble, ionic monomers and maleic anhydride. The microspheres may be prepared by aqueous suspension polymerization utilizing emulsifier in an amount greater than the critical micelle concentration in the absence of externally added protective colloids or the like.

Another preferred pressure sensitive adhesive for use in the present invention can be of the type described in U.S. Pat. No. 5,053,436, in the following also referred as “second adhesive”. The adhesive described in U.S. Pat. No. 5,053,436 comprises or essentially consists of hollow, polymeric, acrylate, inherently tacky, infusible, solvent-insoluble, solvent-dispersible, elastomeric pressure-sensitive adhesive microspheres having diameters of at least about one micrometer. Preferably a majority of the hollow microspheres contain one or more interior voids having diameters at least 10% of the diameter of the hollow microspheres. These microspheres are useful as repositionable pressure-sensitive adhesives. Preferably the pressure-sensitive adhesive consists essentially of hollow, polymeric, acrylate, inherently tacky, infusible, solvent-insoluble, solvent-dispersible, elastomeric microspheres comprising at least about 85 parts by weight of at least one alkyl acrylate or alkyl methacrylate ester, and up to about 15 parts by weight of at least one polar monomer, a majority of the microspheres having one or more interior voids having a diameter of at least about 10% of the diameter of the microsphere. Aqueous suspensions of these hollow microspheres may be prepared by a two-step emulsification process comprising the steps of, forming a water-in-oil emulsion of an aqueous solution of polar monomer(s) in oil phase monomer(s), forming a water-in-oil-in-water emulsion by dispersing the water-in-oil emulsion into an aqueous phase, and initiating polymerization preferably by application of heat or radiation. Aqueous suspensions of hollow microspheres which contain moderately ionized polar monomer(s) may also be prepared by a simpler (“one-step”) emulsification process comprising aqueous suspension polymerization of at least one alkyl acrylate or alkyl methacrylate ester monomer and at least one non-ionic polar monomer in the presence of at least one emulsifier which is capable of producing a water-ill-oil emulsion inside the droplets, i.e., the liquid stage of the microspheres prior to the completion of polymerization, which is substantially stable during emulsification and polymerization. Both methods produce an aqueous suspension of monomer droplets which upon polymerization become microspheres, a majority of which have at least one interior cavity that, upon drying, becomes a void. Alkyl acrylate or methacrylate monomers particularly useful in preparing the hollow microspheres and pressure-sensitive adhesives described in U.S. Pat. No. 5,053,436 are those monofunctional unsaturated acrylate or methacrylate esters of non-tertiary alkyl alcohols, the alkyl groups of which have from 4 to about 14 carbon atoms. Such acrylates are oleophilic, water emulsifiable, have restricted water solubility, and as homopolymers, generally have glass transition temperatures below about −20° C.

The sheets 42 can be of any desired format, wherein the preferred width of the sheets 42, defined parallel to the width of the band 40, is in the range of 30 mm to 150 mm. The preferred length of the sheet 42, defined parallel to the longitudinal direction of the adhesive band 40, is in the range from 30 mm to 200 mm, preferably 30 mm to 155 mm.

The sheet may be rectangular or square. The size of sheets 42 may be for instance in sizes like the typical note pads from the commercial brand “Post-it®” pads available from 3M Company, e.g. a width of 38 mm×a length of 51 mm, 76 mm×51 mm, 76 mm×76 mm, 76 mm×127 mm or 152 mm×1000 mm.

The width 3 of the adhesive band depends inter alia on the size of the sheets and is typically about 10 to 20 mm, preferably about 15-18 mm for note pads.

The note pad assembly 10 may further include a protective back sheet or back card (not shown in FIG. 3) made of paper or made of a stiff material having a front surface to which the rear surface of the bottom most sheet 42 in the pad is attached. The front surface of the back sheet is preferably coextensive with the sheets 42 in the pad, and the protective back sheet or back card may have a top portion projecting past the aligned first edges 15 of the sheets 42. The top portion may have a peripheral support edge generally parallel to the first edges 15 of the sheets 42.

Test Methods

The following describes test methods which allow defining the wall-hang performance of a product.

In the test, sheets according to the invention are applied to five different types of surfaces. The five different surfaces are: (i) wall paper painted with low-cost vinyl; (ii) an acrylic surface with a green paint; (iii) an ABS; (iv) wall paper painted with high-cost vinyl; (v) a wall carpet. In the test made with surfaces (i) to (iv) the sheets are subjected to ventilation. In the test with surface (v), the sheets according to the invention are not subjected to ventilation. For the experiments, the sheets are applied onto the surfaces using rollers having a weight of 2 kg or 160 g. All test sheets have the same size (76 mm×76 mm).

The distance from the wall to the ventilator is about one meter, wherein the ventilator is a standard commercially available ventilator with a maximum power of 45 Watts (for example the “Desk Fan VL 45.0” from White & Brown Electromenager, France) that can be set to 3 different speeds (Velocity 1 “low”, Velocity 2 “medium” and Velocity 3 “high”) and which rotates back and forth around a vertical axis at an angle of about 90-1.00 degrees and about 5 6 times per minute. The entire test setup is arranged in an enclosed room which has dimensions of about 3 m by 3 m.

After each test, a cleaning of the panels is necessary, using a tissue with soap water. It is verified that no adhesive is left over. At the end, the surface is cleaned with a wet cloth without detergent, ensuring that no detergent is left over prior to the application of the sheets. The tests are carried through the following two different protocols:

(I) The “Standard protocol” allowing testing the performance of the adhesive without taking into account any external parameter besides the nature of the adhesive; and

(II) The “real-life protocol” simulating the real-life use, taking into account the performance of the adhesive, but also that of the LAB (low adhesion backsize).

The tests were carried out in the following sequence with seven steps, wherein each test was carried out with a maximum of six samples (with one internal reference).

(I) Standard protocol: 1. The samples had the format 654 (76 mm×76 mm); 2. The width (and also the position) of the adhesive stripe was either 15 mm or 10 mm as set out in FIG. 6; 3. The panels as described above were placed horizontally on a table; 4. Six notes per sample were placed with the following procedure: The note was removed from the pad at a small angle so that curling was avoided and the samples were placed to the panel; 5. The note was laminated onto the panel passing the roller of 2 kg back and forth once; 6. The panel was placed into the vertical position; and 7. The same procedure was redone with the other panels.

(II) The “real-life protocol” followed the (1) Standard Protocol with the exception of step 4, whereas each sheet was removed from the pad at an angle of 180° causing a curling of the sheet.

The test sequence had a duration of seven days with a change of the velocity of ventilation. The ventilators were arranged so that they blowed in a vertical direction and were turned on simultaneously. At the end of every day the number of notes remaining on the panel were counted. This was then recorded in tables, which indicated the different samples, the different surfaces and the individual days. At the end of the sequence of seven days, the number of notes for each sample were counted and compared to the reference. At the end of the entire test, the panels were cleaned as described above.

The purpose of the tests is to demonstrate the behavior of sheets having an adhesive band 40 directly at the edge of the sheet as compared to sheets having a displaced band 40. Typically, when the sheets 42 have the dimensions of 76 mm×76 mm, the band width 3 in a number of typical experiments is about 14 to 16 mm. Accordingly, the first and second predetermined spacings 1 and 2 are about 30 mm for a completely centralized adhesive band 40.

The graph of FIG. 5 shows the dependency of the wall-hang performance on the displacement of the adhesive band 40, i.e. the first predetermined spacing 1, for two different adhesives. The first adhesive corresponds to the adhesive according to U.S. Pat. No. 3,691,140 and the second adhesive corresponds to the adhesive according to U.S. Pat. No. 5,053,436. The wall-hang performance is measured according to the test as described above. In the graph of FIG. 5, the wall-hang performance is indicated in percent, i.e. if all sheets remain on the respective surfaces at the end of a test sequence, a value 100% is reached. It can be seen that location of the adhesive band 40, i.e. displacement by a first predetermined spacing 1 from the first edge, dramatically improves the wall-hang performance. For both adhesives, the highest wall-hang performance can be achieved with a centered adhesive band 40, wherein the first and second predetermined spacings 1 and 2 are 30 mm for a 76 mm×76 mm sheet with 16 mm width 3 of the adhesive band 40. The combination of the second adhesive with a centered adhesive band 40 achieves the best results.

FIG. 6 shows, like FIG. 5, the dependency of the wall-hang performance on the displacement, i.e. the first predetermined spacing 1 of the adhesive band 40, for the two different adhesives. In addition to FIG. 5, FIG. 6 shows the influence of two different band widths 3, which are 10 mm and 15 mm for each of the two tested adhesive bands 40 as indicated. The wall-hang performance is again indicated in percent. FIG. 6 shows that the sheets having broader adhesive bands show similar or only slightly better performance.

In further tests, it was tested whether it may be advantageous to have a plurality of relatively small stripes rather than one single wide band 40. Therefore, tests have been conducted with a standard band 40 of a width 3 of 15 mm and multi-stripes with four individual stripes 45 of a width of 2 mm, spaced by areas without adhesive 46, so that they had a total width 3 comparable to the single band 40 as illustrated in FIG. 4. Configurations according to the present invention with a plurality of stripes 45, which are all arranged in the centered position of the sheet as shown in FIG. 4, were compared with the configuration with a single adhesive band 40 arranged in the centered position of the sheet as shown in FIG. 2.

TABLE 1

| Sample | Wall-hang (% of remaining notes) |
|---|---|
| Single middle stripe (15 mm) | 53 |
| 4 middle stripes | 60 |

It can be seen that an arrangement with multiple stripes is operational as well and shows similar results as a single band configuration. Under normal circumstances multiple stripes 45 do not provide substantial advantages. However, multiple stripes 45 could be useful for specific problems. Multiple stripes provide the property that, when removing them from the surface they are attached to, the removal is not uniform, but goes “in waves”. This may provide a more tactile feeling for the user when removing a sheet.

As a conclusion from the test results it can be seen that the displacement of the adhesive pressure sensitive band from the edge of the sheet according to the invention provides an enhanced wall-hang performance for different adhesives and different band widths of the adhesive and different arrangements of the adhesive within the band.

On the other hand, comparative tests with an increased adhesive coat weight have been made. In these tests, the wall-hang performances of sheets with standard adhesive coat weight and about 50% increased adhesive coat weight have been tested according to the test methods described above. These tests have shown that the increase of the adhesive coat weight of about 50% of a specific adhesive does not improve wall-hang performance significantly, if the adhesive is conventionally provided at the edge of the sheet.

Similarly, comparative tests have shown that a wider adhesive band of 22 mm width instead of the 16 mm standard width had also only a limited impact on the wall-hang performance if the adhesive band is conventionally provided at the edge of the sheet. The relatively small impact of the band width can be seen for instance in FIG. 6, wherein the wall-hang performances of sheets with adhesive band widths of 10 mm and 15 mm are depicted.

The present invention has now been described with reference to some embodiments thereof. It will be apparent to those skilled .in the art that many changes can be made in the embodiments described without departing from the scope of the present invention.

1-11. (canceled)

12. A pad assembly comprising:
a plurality of flexible sheets (42), each sheet being generally rectangular, of the same size and said sheets (42) having front (41) and rear (43) surfaces and peripheral edges including first (15) and second (16) opposite edges, said sheets having a band (40) of repositionable pressure sensitive adhesive coated on said rear surface (43) for adhering adjacent sheets together,
said band (40) being substantially parallel to the first (15) and second (16) edges and being spaced by a first predetermined spacing (1} from said first edge (15) and by a second predetermined spacing (2) from said second edge (16),
wherein the ratio between the first predetermined spacing (1) from the edge (19) of the band (40) closest to said first edge (15) to said first edge and the second predetermined spacing (2) from the edge (20) of the band (40) closest to said second edge to said second edge (16) is in the range of 0.1 to 10.

13. The pad assembly of claim 12, wherein said band (40) comprises a plurality of repositionable pressure sensitive adhesive stripes (45) being substantially parallel to the first (15) and second (16) edges and being spaced from neighboring stripes by areas (46) which comprise no adhesive.

14. The pad assembly of claim 12, wherein said band (40) of repositionable pressure sensitive extends continuously across the rear surface of said sheet between a first side edge (13) and a second side edge (1.4), which side edges are perpendicular to the first (15) and second (16) edge.

15. The pad assembly of claim 12, wherein the ratio between the spacing (1) from the edge (19) of the band (40) closest to said first edge (15) to said first edge and the spacing (2) from the edge (20) of the band (40) closest to said second edge to said second edge (16) is in the range of about 0.25 to 4.

16. The pad assembly of claim 12, wherein the width of the flexible sheets (42) is in the range of about 30 mm to 150 mm and the length of the flexible sheets (42) is in the range of about 30 mm to 200 mm.

17. The pad assembly of claim 12, wherein the ratio between the area of the rear side which is coated with adhesive to the area without adhesive is in the range of about 0.1 to 0.4.

18. The pad assembly of claim 12, wherein the ratio between the width (3) of the band (40) perpendicular to the first edge (15) and the sum of the first predetermined spacing (1) and the second predetermined spacing (2) is in the range of about 0.1 to 0.4.

19. The pad assembly of claim 12, further including a protective back sheet or back card having a front surface, the rear surface of the bottom most sheet in the pad being adhesively attached to the front surface of the back sheet or back card, and the front surface of the back sheet or back card being at least coextensive with the sheets in the pad.

20. The pad assembly of claim 12, wherein the band (40) of repositionable pressure sensitive adhesive is the only means which connects two adjacent sheets.

21. A method of applying an adhesive sheet to a surface, with the steps of:
peeling an uppermost sheet from the pad assembly of claim 12, and
adhering said sheet to said surface.

22. A method according to claim 21, wherein said surface is generally vertical.
